(19) United States
(12) Patent Application Publication
(10) Pub. No.: US 2014/0261149 A1
(43) Pub. Date: Sep. 18, 2014

(54) CONTINGENCY NOTIFICATION AND ASSISTANCE DEVICE FOR DIVERS IN DISTRESSED SITUATIONS

(71) Applicant: Ben Amini, Oakland, CA (US)

(72) Inventor: Ben Amini, Oakland, CA (US)

(21) Appl. No.: 13/832,418

(22) Filed: Mar. 15, 2013

(51) Int. Cl. G08B 5/00

(52) U.S. Cl. CPC G08B 5/002
USPC 116/201; 116/210

(57) ABSTRACT

A system for assisting a distressed diver in order to communicate with the surface includes a housing that includes a portion containing a gas canister and an upper portion that is in fluid contact with an expandable balloon. By manipulating the upper portion, a needle or other activation mechanism dispenses the gas in the canister and allows the balloon to inflate. The housing is lifted by the balloon to the surface and is attached to a lockable spool reel tethered to the diver. The balloon may be also inflated for other uses in buoyancy, notification, and to frighten potentially dangerous threats when the spool reel is locked at an appropriate depth.

### BACKGROUND

The safety of commercial or recreation divers diving, (especially at night and/or below 30 m), is precarious. Electromagnetic signals at such a depth are useless, and lines of visibility are on the order of 1-2 m. What is needed is a cost-effective tool that can help distressed divers communicate with the surface and/or other divers.

### SUMMARY OF THE INVENTION

In life threatening or distressed situations, a distressed diver can send a “signal” to the surface by easily activating a specialized compressed gas dispenser into a specialized balloon. The balloon travels to the surface and floats, or, if filled with Helium, it can go above the surface for better visibility. The housing containing the dispenser and the balloon stays connected to the diver below the surface through a retractable reel that is connected to the diving vest and for easy access to diver follow the line.

In addition, wild animals do not like surprises and big distractions. Activating this device with special markers printed on a colored balloon can abruptly make the diver appear larger, if the reel is locked so the balloon does not travel to the surface. This, in turn, can deter any wild sea animals such as sharks or any animal attempting to attack the diver. This will distract the threatening animal and can be a handy deterrence tool for the diver. In addition, in another embodiment of the invention, the compressed air can also be mixed with colored dyes to distract or blind the predator when pointed at the subject can escape. The ink (which is environmentally green vegetables dyes in a preferred embodiment) is propelled out of the cartridge pointed at the predator.

The balloon notification embodiment of the invention is particularly useful under the following circumstances: (1) during night dives, if the diver gets separated from the group, the device can be activated with night glowing balloon (an optional embodiment of the invention) exposing the diver in distress and the group can find the diver. In this case, the balloon can be raised any amount above the diver so other divers in the group can see the distress diver and unite with them. (2) If the diver is stuck, for example in kelp beds, activating the device can also add substantial lift power to break free from entanglement.

The system, alternately, can be used in a rescue mission to aid the distressed person float on the surface without jeopardizing the safety of the rescuer. The rescued person can then get pulled via the attached cord in the device to safety.

In still yet other applications of the invention, the system can be activated to signal the surface operators in boats or jet skis the diver is surfacing to avoid accidental collision. In yet another application, the instructor diver can use the device to signal different messages to a ship captain without having to surface and abort the dive. The lifting power of the device can be used to lift items to the surface, where the diver does not need to come to surface and abort the dive. An LED strobe light can be attached to the device and an electronic GPS device can be attached to signal the exact location of the distressed diver.

### BRIEF REFERENCE TO THE DRAWINGS

FIG. 1 illustrates a schematic of the invention in a primary embodiment;

FIG. 2 illustrates a schematic of the operation of the invention in a primary embodiment;

FIG. 3 illustrates an operation of the canister in a first embodiment;

FIG. 4 illustrates detail of the activation canister in a primary embodiment;

FIG. 5 illustrates detail of the activation canister in a second alternate embodiment;

FIG. 6 illustrates an alternate operation of the invention;

FIG. 7 illustrates an additional feature of the invention using a help flag; and

FIG. 8 illustrates a “balloonless” embodiment of the invention using dye.

### DETAILED DESCRIPTION OF THE INVENTION

Referring now to FIG. 1, a main embodiment of invention is shown in a schematic of functional parts (and not to size). The housing or activation canister H serves several functions, but primarily to “activate” the balloon B (or inflatable warning system B), with an activation needle or activation device IA that can come in a variety of forms without departing from the scope of the invention.

The spool reel SR can be in the form of a generalized lockable L or non-lockable with a cord (and in a preferred embodiment) such a 130′ cord. The spool reel can be locked, released or spring-loaded. For various embodiments of the invention, it is preferred that the distressed diver have the option to keep the spool locked or unlocked. However, it is contemplated that for the primary embodiment of the invention, which is to propel the notification balloon B to the surface, the spool reel SR will stay unlocked. However, if the embodiment (and it can be the same embodiment) of the invention is being used to frighten away a dangerous animal (as to appear larger) or notify other divers in the vicinity, used for buoyancy the spool SR will stay locked so the balloon B does not rise to the surface (these embodiments are discussed below). The buoyancy of the diver increases as the device is activated and the diver will ascend if no adjustment is done to the diver's buoyancy (see below).

In the operation of the invention, the inflation activator IA, which is shown in the form of a dispensing mechanism N (which is shown in the form of a needle, but may be other mechanisms, which are discussed below) that “punctures” a seal or otherwise activates a dispensing mechanism DM on the gas canister GC. The gas canister C is fluidly connected to the balloon B through the top of the activation module AM, which houses the needle or inflation activator. The balloon B is sealed by the balloon attachments BA1 and BA2 on the activation module AM part of the housing H, such that no gas from the canister GC leaks out of the housing H after the canister GC has been activated.

The balloon attachments BA1 and BA2 may be as simple as a continuous elastic sealing ring (not shown), clamps (not shown) or other device that securely attaches the balloon B to the activation module AH. It is critical for operation of the device to have a strong airtight seal between the balloon B and activation module/housing AH, even though the elastic nature balloon B (for example, if it made of high-quality latex) may provide a great deal of sealing by itself. It is important to the invention that expansion of the balloon B as it ascends to the surface does not compromise the airtight seal, as an important aspect of the invention is that the balloon B can optionally rise above the surface of the water if helium is dispensed into the balloon B from the gas canister GC.

In a preferred embodiment, the Spool reel SR is attached to the housing attachment HA by the spool cord SC, which is retractable into the spool reel SR. The spool reel SR is also generally attached to one or more safety hooks of one or different varieties (shown as H/H′) through a non-retractable cord(s) AC/AC′ that attach to the vest of the diver (not shown). The non-retractable cord may AC/AC′ be elastic for more flexibility. The spool cord SC may be standard cord, or heavy fishing line, or in some embodiments, colored for high visibility.

In general, it is thought that the main configuration of the invention may (or may not, depending on the embodiment, see alternate embodiments below) regulate the inflation of the balloon B though mechanical means, such that the inflation of the balloon will be limited as it rises to the surface will allow the balloon to maintain its physical integrity (against the Boyle forces). However, there are simple mechanical and electronic devices that can assist in regulating the amount of gas allowed to flow into the balloon as it rises towards the surface without adding greatly to the expense of the invention. Thus, it is contemplated that in certain implementations of the invention, these regulation devices may be part of the invention and allow a safer operation.

Referring now to FIG. 2(1-3), the operation of the activation module/canister AC is shown. The activation module AH can be activated by any number of mechanisms (and are discussed in the figures below), but in a preferred embodiment can be activated by a single hand by placing pressure either on the top of the housing or activation hood AH or pushing on the bottom of the housing LH, in either case, the seal DM on the gas canister (whether in the form of an actual seal or other dispense mechanism) is broken by the needle IA (or other activation mechanism IA that activates the gas to flow from the canister) allows fluid contact between the gas canister CG and the balloon B, through the activation module/hood AH. In other embodiments which are discussed below, a threaded screw between the upper activation housing AH and lower housing LH the will provide the needed pressure between the two sections to cause the activation mechanism to trigger the dispense mechanism DM and the gas to flow (see below).

Initially, the completely deflated balloon B ideally sits tight against the upper part of the housing or activation hood AH in FIG. 2(1). In FIG. 2(2) when the activation hood AH is twisted or pressed or otherwise activated to cause the gas from the canister GC to dispense into the balloon B, the balloon will have a certain volume of gas V1 before it starts to have buoyancy and move the housing H upwards. In FIG. 2(3) the balloon B now has enough volume V2 that it will move the housing unit to the surface while attached to (unlocked) the spool cord SC, while the balloon is still slowly being inflated.

In referring to FIGS. 2(1-3), it is also important that the balloon only be inflated enough to start the housing moving upwards. Thus, the needle or other dispense mechanism DM should be configured such that it activates the gas canister GC to let just enough gas into the balloon, such that the balloon rises to the surface swiftly, but with only the needed amount of buoyancy. Boyle forces will continue to expand the balloon as it rises to the surface. Thus, the gas canister should (1) create enough gas in the balloon, but not (2) inflate the balloon B such that it will burst before it reaches the surface. Thus, the balloon B, must be made of a high-quality material so that it can stretched beyond its recommend limit and still function properly.

In configuring the rate of gas released by the gas canister, it should be kept in mind that the volume of the gas in the balloon will essentially double approximately every 10 m (33 ft), the balloon B should be made of a durable material that will expand beyond its recommended elastic capabilities, as the safety range of the balloon is generally made for professional divers who will be operating at various depths. Materials such as Kevlar are strong, but have limited elasticity once they are fully inflated, so configuring the gas released from the gas canister at a low end would be an important consideration in using such material for a balloon. Other high-quality elastic materials, such as latex and vinyl may be used for the balloon and allow for more flexibility in the gas exchange between canister GC and balloon B. However, the balloon material should be easily compacted into the section of the activation hood AH of the housing. In alternate embodiments not illustrated the balloon B may be may of translucent material or include translucent dyes so that it may assist for safety in night dives.

FIG. 3 refers to a first embodiment of the balloon activation canister, in which the upper portion or activation module/housing AH. The top portion or activation housing AH is threaded with a first threading UT and a lower portion LH that contains the gas canister GC is also threaded with a second threading LT that screws into the upper threading UT. The dispense mechanism DM of the gas canister GC is activated by twisting the activation housing AH down, such that the needle or other activation mechanism IA released the gas of the gas canister GC into the balloon B. Vital to this embodiment is that the gas released through the top of the activation mechanism/housing AH directly into the balloon B. Also, the activation mechanism IA should be limited so that it doesn't release too much gas into the balloon on its initial ascent (see FIGS. 2(1-3) above).

In a preferred embodiment, the activation module is designed to be activated by one hand as it is anticipated that the canister may come into fluid contact with the activation module by twisting the top of the housing and a tap or push of one section into the other. In FIG. 4, the gas canister is activated by twisted the activation housing AH a quarter-turn (or other degree) so that the posts on the lower housing LH line up with the indents FS on the activation housing AH allowing the dispensing mechanism DM on gas canister GC to be activated by the activation mechanism IA when the top (or bottom) housing are tapped such that the gas fills the balloon (not shown) though the fluid ports F. This particular embodiment allows the balloon system to be activated with one hand when locked into place and “tapped” against the scuba tank or the diver's leg.

Referring now to FIG. 5, another embodiment is shown in which the dispensing mechanism DM on the gas canister GC is activated by flipping an optional housing lock HL so that the sections may be tapped or pressed together with a single hand resisting the spring forces S keeping the housing sections apart, much like the embodiment shown in FIG. 4.

In a preferred embodiment, the Spool Reel SR, in the device has an internal spring. As it surfaces when activated, it winds a spring (not shown). When the receiving person on the surface deflates the balloon, it can be automatically wound back into the diver's spool without the diver having to manually rewind the cord into the reel.

The gas cartridge GC may be interchangeable in various embodiments from compressed gas (air) to Helium to and may also include colored dyes depending on the intended end uses. In a preferred embodiment, the cartridge is an easily available CO2 cartridge, but also could include an easily available NO2 cartridge, but generally will have to provide enough gas to inflate the balloon B to a noticeable size for the notification system to be effective. For example, a helium cartridge may be more expensive, but also provide the additional security in the notification system, by allowing the balloon to extend beyond the water surface to limit of the spool reel cord. In general, the device is designed to be reusable; the only one time use is the compressed gas in the gas canister. Used compressed gas is easily replaced at minimal expense. A one-time use may also be contemplated in various embodiments to keep the costs down.

FIG. 6 demonstrates one of the several alternate embodiments of the invention as it may be used. In FIG. 6, a Diver D, well below the surface, using the notification/safety system, determines there is a threat T of some sort, most notably a natural threat like a shark. The diver D, locks the spool reel SC, and activates the canister in the housing H (discussed above), such that the balloon B inflates to a larger degree than it normally would in the simple use of the device as a safety notification system (when it is predicted to inflate naturally due to Boyle forces, however, it is also contemplated that the balloon would be fully inflated near the diver in order to gain benefit from the size of the balloon to scare predators). Thus, when the balloon is inflated for the alternate use, the diver D unlocks the spool reel SR for a short period of time so that it travels distance X′ while still being attached but continues to inflate. An optional pattern P may provide additional safety for the diver D by scaring the natural threat T. Thus, the balloon may give the impression that the diver D is much larger or dangerous to the natural threat T than without the balloon. Alternately, the balloon B may be filled with dyes that may help the diver D avoid some other threat if the balloon is inflated enough to dispense such dyes at the proper time (see below).

FIG. 7 shows another variation on the invention in which there is an additional help flag F attached to the spool line SL, such that when the balloon B is at the surface, the help flag F is located about 10-15′ from the diver (or other optimal distance), so that not only is the surface notified of the diver's distress, so are other divers. The help flag F will be made of material that is easily compacted but unfolds when unpacked and raised.

In another alternate embodiment shown in FIG. 8, a “balloonless” notification system is shown and is generally used to propel warning (environmentally safe) dye into the water. The dye may be a part of the condensed gas and inside the cartridge (not shown) or there is a separate dye housing DH, which is activated in the same ways as shown in FIGS. 3-5 and the canister GC is activated using the pressure to distribute dye D in the dye housing through ports P. In general, in a preferred configuration the dye housing DH will “clip into” the lower housing LM which contains the gas canister.

Additionally, the balloon B can be used in a variety of ways when it is locked by the spool reel SR. The balloon B may be used to provide lift to a distressed diver or to take objects to the surface.

The application of the invention may also be useful in other scenarios like stranded boats, hikers, cross country skiers when the balloon is activated with helium in the gas canister. Other features can improve the notification applications of the system, such as electronic signals or printed notifications (such as “SOS” etc) or a strobe light. Thus, a notification balloon lifted 10-20 m in the air can provide additional chances of rescue where electronic signals may prove inadequate.

The previously discussed embodiments are meant to be illustrative only and are not a comprehensive list of the embodiments of the invention.

1. A safety notification system for a diver including:
A housing attachable to diving equipment, said housing including a gas canister filled with a compressed gas and an activation module operatively attached to said canister, and a balloon, wherein said activation module is connected to said balloon with an airtight seal;
A lockable spool reel connected, said reel connect to said housing, and an attaching hook connected to said spool reel;
wherein said activation module is in fluid contact with and allowing said gas canister to fill said balloon when activated, said balloon filled enough to move said housing towards the surface.

2. The safety notification system as recited in claim 1, wherein said housing is comprised of two sections connected by a tension or spring member, a first section including said gas canister, a second section including said activation module, wherein when said first section and said second section are compressed, a mechanism in said activation module

3. The safety notification system as recited in claim 1, wherein said housing is comprised of two sections, wherein said sections are screwed together, and a gas canister is activated to release compressed gas by twisting said parts together.

4. The safety notification system as claimed in claim 1, wherein said balloon is made of Mylar, Latex or vinyl.

5. The safety notification system as claimed in claim 1 wherein said activation module is automatically operated.

6. The safety notification system as claimed in claim 1, wherein, said gas in said gas cartridge is helium, where by said balloon will move above a water surface.

7. A safety system for a diver including: a housing made of two sections: a first lower section threaded at a top portion and a canister contained therein, said canister filled with a compressed gas; a second upper portion, said upper portion including a threaded portion at a bottom end such that said upper threaded portion of said lower section screws into said upper threaded portion; an activation mechanism, said activation mechanism releasing compressed gas in said gas canister when said upper portion is twisted onto said lower portion said released gas into fluid contact through upper portion with a balloon, wherein said balloon is sealed again said upper portion of said housing.

8. The safety system as recited in claim 7, further including a retractable spool-able tether attached to said housing, said spool-able tether extending from a lockable spool reel.

9. The safety system as recited in claim 8, further including a second tether connecting said lockable spool reel to a closeable hook.

10. The safety system as recited in claim 7, wherein said balloon is made of Mylar or Kevlar.

11. The safety system as recited in claim 7, wherein said balloon is made of an elastic material.

12. The safety system as recited in claim 7, further including a help flag, said help flag connected to said spool reel and configured to be seen below the surface of the water.

13. The safety system as recited in claim 7, wherein said compressed gas is helium.

14. A method for assisting a underwater diver, including the steps of:
tethering a lockable spool reel to said diver;
activating a housing attached to said lockable spool reel, to release gas into a balloon, said housing including a first lower part and a second upper part, said lower first part including a gas canister with a compressed gas, said upper part in fluid contact with said balloon, wherein said second upper part causes said gas canister to release gas into said balloon when manipulated;
filling said balloon to a first volume;
unlocking said spool reel such that said balloon rises a certain distance;

15. The method as recited in claim 14, further including locking said spool reel when said balloon has reached a desired depth.

16. The method as recited in claim 14, wherein said manipulation includes screwing said first part into said second part.

17. The method as recited in claim 14, wherein said manipulation includes releasing a lock and pressing said first part into said second part.

18. The method as recited in claim 14 further including the step of attaching an object to said housing prior to inflating said balloon.

19. The method as recited in claim 14, wherein said gas is Helium.

20. (canceled)
